(19) United States
(12) Patent Application Publication
(10) Pub. No.: US 2004/0202069 A1
(43) Pub. Date: Oct. 14, 2004

(54) Actuator for controlling voltage sensitivity and phase and optical pick-up device equipped with the same

(75) Inventors: Ho-Seop Jeong, Kyunggi-Do (KR); Yong-Han Yoon, Kyunggi-Do (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/733,341

(22) Filed: Dec. 12, 2003

(30) Foreign Application Priority Data
Apr. 9, 2003 (KR) 2003-22421

(51) Int. Cl. G11B 7/095

(52) U.S. Cl. 369/44.32; 369/44.41; 369/53.19

(57) ABSTRACT

Disclosed are a moving-magnet type actuator capable of controlling voltage sensitivity and phase, an optical pick-up actuator equipped with a current feedback circuit for improving voltage sensitivity, and an optical pick-up device equipped with the current feedback circuit implemented by one chip. As the voltage sensitivity of a moving-magnet type actuator is improved and its phase is compensated, the operation performance of the optical pick-up actuator can be improved.

### BACKGROUND OF THE INVENTION

1. Field of the Invention

The present invention relates to an actuator capable of controlling voltage sensitivity and phase and an optical pick-up device equipped with the same, and more particularly to an optical pick-up actuator equipped with a current feedback circuit for improving voltage sensitivity in conjunction with a moving-magnet type actuator for performing a tilting operation of an optical pick-up.

2. Description of the Related Art

In general, optical pick-ups are adopted in optical recording/reproduction apparatuses. An optical pick-up performs recording and/or reproduction of information with respect to a recording medium, such as an optical disc, placed on a turntable in a non-contact manner while moving in a radial direction of the optical disc.

The optical pick-up includes an object lens which forms a light spot on the optical disk by focusing light emitted from a light source, and an actuator which controls the object lens in a tracking direction, a focusing direction and a tilting direction. The optical pick-up applies an electric current to a coil within a predetermined magnetic field so that the object lens can be driven. Here, the actuator of the optical pick-up is a device for accurately positioning the light spot formed by the object lens on a surface or track of the optical disc.

On the other hand, an apparatus for reading and writing information using the optical disc has been required to have a high drive precision in accordance with the recent trend of an increase in the storage capacity of the optical disc. As the storage capacity of the optical disc increases, the number of apertures of object lens increases. A lens aberration can be caused by a tilt of the disc due to the increase in the number of apertures. Because of the lens aberration, a playback performance of the optical disc can be degraded. At a time of writing information, pits can be inappropriately formed on the optical disc due to the lens aberration and hence written signals corresponding to the inappropriately formed pits can be degraded.

For this reason, there is needed a device for correcting the tilt of the optical disc along with focusing and tracking operations. There have been proposed methods for correcting the tilt of the optical disc. The above-described methods include a method for moving the entire optical pick-up using a direct current (DC) motor and another method for correcting the tilt of the optical disc by moving only an optical pick-up driver.

The method using the DC motor has disadvantages in that only the tilt of the disc is corrected in a low-frequency band, and the size of an optical playback device increases.

Further, a method for moving only a blade of the optical pick-up actuator is classified into a moving coil type and a moving magnet type according to a coil and a magnet attached to a driver. Conventionally, there is mainly used a two-axis actuator of the moving coil type as the optical pick-up actuator. In accordance with a need of a high-density optical disc, a three-axis actuator for controlling the tilt of the optical disc is used.

However, in a three-axis driving actuator of the moving coil type, at least six wires are connected to a driver in order to control the tilt of the disc. In this case, there is a problem in that an operation of assembling components is complicated. In the actuator of the moving magnet type, it is difficult for driving voltage sensitivity, required for the object lens set on the blade, to be ensured.

Next, conventional actuators and conventional methods for driving the same will be described with reference to FIGS. 1 to 4.

FIG. 1 is a perspective view illustrating a conventional moving-magnet type actuator, and FIG. 2 is a perspective view illustrating a conventional moving-coil type actuator. Referring to the conventional optical pick-up actuators of the moving magnet and coil types, advantages and disadvantages of their driving characteristics are as follows.

FIG. 1 is a perspective view illustrating an optical pick-up actuator (disclosed in Japanese Patent Publication No. 1998-261233). In the optical pick-up actuator, magnets 3 are installed on a blade 2 on which an object lens 1 is mounted to focus a laser beam from an optical disc. A coil 5 is wound around a yoke 4-1 of a yoke plate 4 mounted on a lower surface of the blade 2 corresponding to the magnets 3. To obtain necessary sensitivity, the number of coil windings must be increased. However, there is a problem in that the increased number of coil windings causes a phase delay.

FIG. 2 is a perspective view illustrating a conventional moving-coil type actuator. In a conventional two-axis driving optical pick-up actuator, a focusing coil 6 is installed on a blade 2 on which an object lens 1 is arranged. A plurality of tracking coils 7 are installed on both sides of a longitudinal direction of the blade 2 on which the focusing coil 6 is arranged. Magnets 3 arranged at opposite sides of the tracking coils 7 are attached to a plurality of yokes 4-1 being vertical to a yoke plate 4. Magnets 5 arranged at opposite sides of the focusing coil 6 are attached to a plurality of yokes 4-2.

In a two-axis driving operation for the object lens 1 performed by the above-described moving-coil type actuator, the magnets 5, attached to the yokes 4-2 separated by a predetermined distance from the focusing coil 6 wound around the blade 2, produce electromagnetic force in the actuator to electro-magnetically move the blade 2 in a vertical direction. Moreover, the magnets 3, attached to the yokes 4-1 arranged at opposite sides of the tracking coils 7, produce electromagnetic force in the actuator to electro-magnetically move the blade 2 in a horizontal direction.

The above-described two-axis driving actuator has an advantage in that design data or facilities used in the existing design can be used. However, the above-described two-axis driving actuator has a disadvantage in that at least two wires must be additionally connected to a plurality of tracking coils. As a result, precision is needed at a time of assembling components and the efficiency of production can be degraded.

The moving-coil type actuator using at least 6 wires has a difficulty in connecting wires to the actuator, and another difficulty in performing wiring for applying voltage to the actuator also when another element such as a liquid crystal display (LCD) is added.

On the other hand, the moving-magnet type actuator has an advantage in simple performance of a wiring step. However, since a magnetic flux density is low in the moving-magnet type actuator, the number of coil windings must be increased such that current sensitivity can be enhanced.

FIG. 3 is a schematic diagram illustrating a conventional optical pick-up capable of controlling optical tilt.

As shown in FIG. 3, the conventional optical pick-up 10 is driven by a tracking control signal V_{T}, a focusing control signal V_{F} and a tilting control signal V_{R} outputted from a system driving integrated circuit (IC) 21 provided in an optical pick-up driver 20. At this time, an adder 22 produces a signal V_{F}+V_{R}, by adding the focusing control signal V_{F} to the tilting control signal V_{R}. A subtracter 23 produces a signal V_{F}−V_{R} by subtracting the tilting control signal V_{R} from the focusing control signal V_{F}. The signals V_{F}+V_{R} and V_{F}−V_{R} are conventionally produced by operation amplifiers. To control the tilt of the optical disc, the tilting control signal V_{R} is combined with the focusing control signal V_{F}, and the combined signals are inputted into the optical pick-up 10.

FIG. 4 is a view illustrating gain transfer functions of a conventional optical pick-up actuator. FIG. 4 shows a model of the conventional optical pick-up actuator.

Here, a transfer function indicates a ratio of an output to an input in an initial state where an initial value is a zero. The transfer function is given by the following Equation 1. In the following Equation 1, R(s), Y(s) and G(s) denote an input, an output and the transfer function, respectively.

$$G ( s ) = \frac{Y ( s )}{R ( s )} , where initial value = 0 \qquad Equation 1$$

In the conventional optical pick-up actuator, the transfer function is given by G(s)=G_{c}(s)*G_{α}(s). At this time, G_{c}(s) 31 denotes a transfer function of a coil, and Gₐ(s) 32 denotes a transfer function of an actuator. As described above, G_{c}(s) and Gₐ(s) are given by the following Equation 2 and Equation 3, respectively.

$$\begin{matrix}{G}_{c} ( s ) = \frac{1}{Ls + R} & Equation 2 \\ {G}_{a} ( s ) = \frac{{K}_{i}}{{s}^{2} + 2 {ζ}_{n} {ω}_{n} s + {ω}_{n}^{2}} & Equation 3\end{matrix}$$

In the above Equation 2 and Equation 3, L, R, ζₙ, ωₙ and Kᵢ denote a coil inductance value, a coil resistance value, an actuator attenuation coefficient, the frequency of actuator vibration, and a current sensitivity value, respectively. In the above Equation 2, since inductance in the moving-magnet type actuator is relatively larger, a phase delay increases and a resistance value increases. As a result, there is a problem in that voltage sensitivity is reduced in the moving-magnet type actuator.

That is, as the coil resistance of the moving magnet actuator increases, the current sensitivity is improved. However, the voltage sensitivity is lowered, and hence a phase delay is caused by the lowered voltage sensitivity. For this reason, the system driving IC 21 for enhancing the voltage sensitivity cannot be appropriately used for the optical pick-up.

### SUMMARY OF THE INVENTION

Therefore, the present invention has been made in view of the above problems, and it is one object of the present invention to provide an optical pick-up actuator equipped with a current feedback circuit, which can increase voltage sensitivity of a moving-magnet type actuator.

It is another object of the present invention to provide an optical pick-up device equipped with a current feedback circuit, which can improve a tilting operation of an actuator by increasing voltage sensitivity of a moving-magnet type actuator.

In accordance with one aspect of the present invention, the above and other objects can be accomplished by the provision of an optical pick-up device, comprising: a system driving integrated circuit (IC) for providing a tracking control signal, a focusing control signal and a tilting control signal to drive at least one actuator; the actuator driven in response to a sum signal and a difference signal, associated with the focusing control signal and the tilting control signal, and the tracking control signal; and a current feedback unit for outputting, to corresponding coils of the actuators, voltages corresponding to the sum and difference signals generated by combining the focusing control signal and the tilting control signal and the tracking control signal, sensing currents applied to the actuator coils, and applying feedback signals to the actuator to control voltage sensitivity and phase of the actuator.

Preferably, the current feedback unit may be implemented by a one-chip application specific integrated circuit (ASIC), and be mounted on a base surface of the optical pick-up device.

Preferably, the feedback signals generated by the current feedback unit may be negative feedback signals.

Preferably, the current feedback unit may comprise: a plurality of coil current sensors for sensing magnitudes of the currents corresponding to the voltages applied to the actuators; a plurality of current-feedback amplifiers for outputting the feedback signals for controlling the voltage sensitivity in response to the sensed coil currents; operation amplifiers for outputting the sum signal and the difference signal associated with the focusing control signal and the tilting control signal; a plurality of adders each outputting an actuator driving signal by adding an output of each operation amplifier to an output of each current-feedback amplifier; and a plurality of amplifiers each amplifying the actuator driving signal and outputting the amplified signal.

Preferably, each coil current sensor may sense a coil current from a voltage at an end of a resistor connected to an actuator coil in serial.

Preferably, a resistance value of the resistor may be 1Ω.

In accordance with another aspect of the present invention, there is provided a tilt actuator being driven in response to a sum signal and a difference signal, associated with a focusing control signal and a tilting control signal, and a tracking control signal, comprising: a current feedback unit for outputting, to corresponding coils of the actuator, voltages corresponding to the sum and difference signals generated by combining the focusing control signal and the tilting control signal and the tracking control signal, sensing currents applied to the actuator coils, and generating feedback signals to control voltage sensitivity and phase of the actuator.

Preferably, the actuator may be a moving-magnet type actuator.

Preferably, the current feedback unit may be implemented by a one-chip application specific integrated circuit (ASIC), and be mounted on a base surface of an optical pick-up.

Preferably, the feedback signals generated by the current feedback unit may be negative feedback signals.

The present invention provides an actuator equipped with a current feedback circuit and an optical pick-up device equipped with the actuator, which can increase voltage sensitivity of a moving-magnet type actuator, thereby improving a tilting operation of the actuator.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a conventional moving-magnet type actuator;

FIG. 2 is a perspective view illustrating a conventional moving-coil type actuator;

FIG. 3 is a schematic diagram illustrating a conventional optical pick-up capable of controlling optical tilt;

FIG. 4 is a view illustrating gain transfer functions of a conventional optical pick-up actuator;

FIG. 5 is a schematic diagram illustrating an optical pick-up device capable of controlling voltage sensitivity in accordance with the present invention;

FIG. 6 is a view illustrating a gain transfer function of an optical pick-up actuator capable of controlling voltage sensitivity in accordance with the present invention;

FIG. 7 is a schematic diagram illustrating the configuration of an optical pick-up device for implementing the gain transfer function shown in FIG. 6;

FIG. 8 is a schematic diagram illustrating an optical pick-up device equipped with a current feedback unit for controlling voltage sensitivity in accordance with an embodiment of the present invention;

FIGS. 9A and 9B are circuit diagrams illustrating a current feedback circuit of the optical pick-up actuator in accordance with an embodiment of the present invention; and

FIGS. 10A and 10B are graphs illustrating a result of voltage sensitivity control and a result of phase correction associated with the optical pick-up actuator in accordance with the present invention.

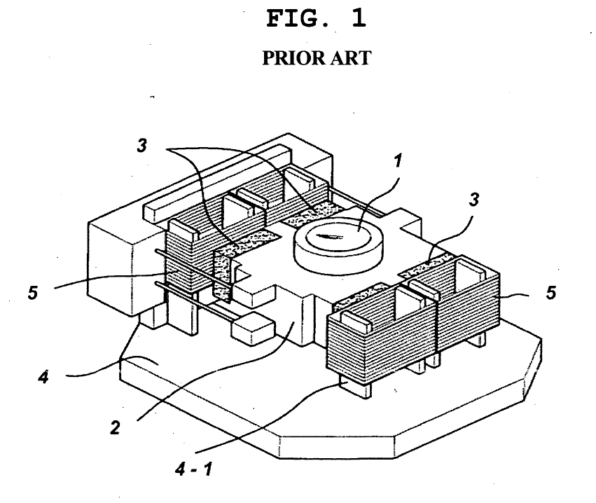

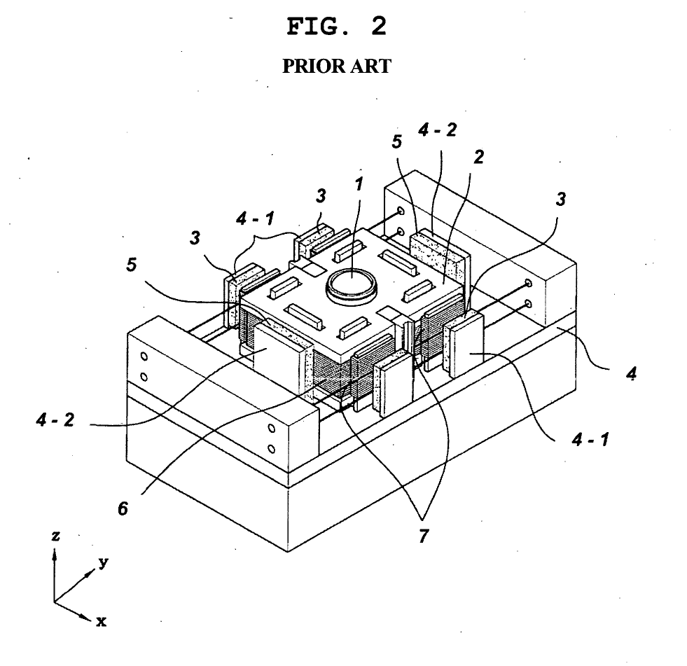

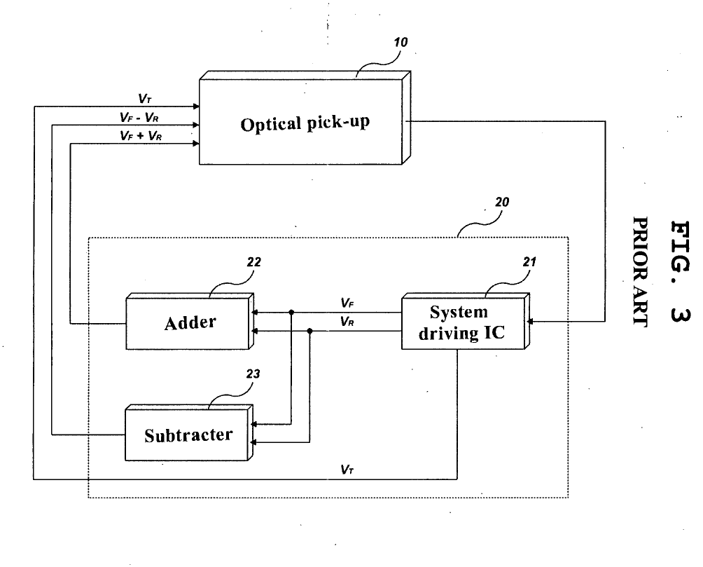

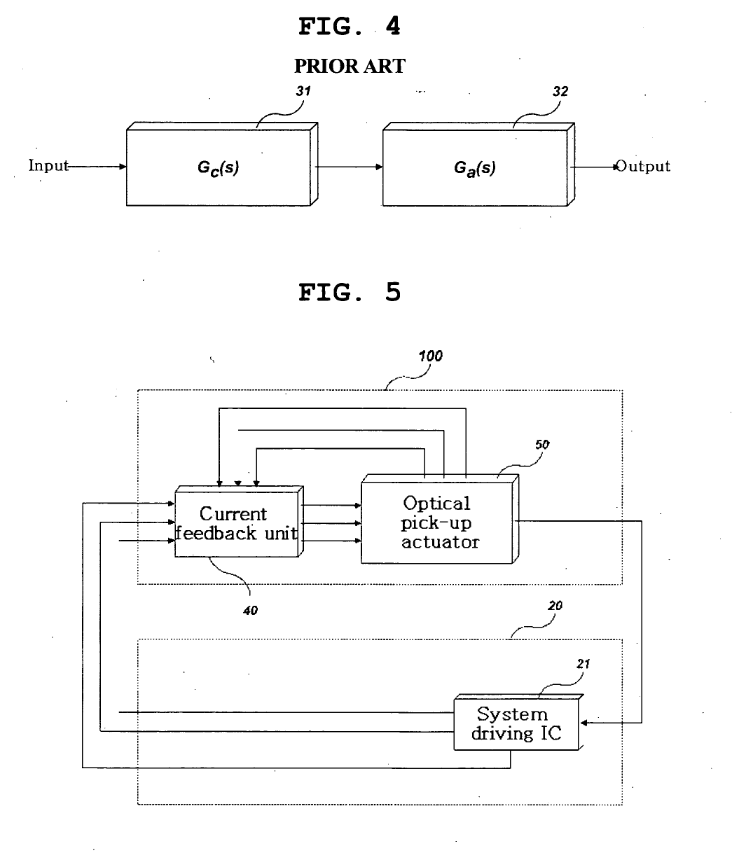

### DESCRIPTION OF THE PREFERRED EMBODIMENTS

Hereinafter, an actuator capable of controlling voltage sensitivity and an optical pick-up equipped with the actuator in accordance with embodiments of the present invention will be described in detail with reference to the annexed drawings.

A conventional moving-magnet type actuator can increase current sensitivity. However, since a resistance value increases, voltage sensitivity is lowered and a phase delay occurs. For this reason, the present invention provides an actuator and an optical pick-up equipped with the actuator, which compensate for the lowered voltage sensitivity and phase delay using a current feedback.

First, FIG. 5 is a schematic diagram illustrating an optical pick-up device capable of controlling voltage sensitivity in accordance with the present invention. In an optical pick-up device, a system driving integrated circuit (IC) 21 outputs a tracking control signal V_{T}, a focusing control signal V_{F} and a tilting control signal V_{R} for driving an actuator 50. A current feedback unit (or a current feedback circuit) 40 outputs, to coils of the actuator 50, electric currents corresponding to a sum signal V_{F}+V_{R} and a difference signal V_{F}−V_{R} produced by combining the focusing control signal V_{F} and the tilting control signal V_{R}. Further, the current feedback unit 40 outputs, to a coil of the actuator 50, an electric current corresponding to the tracking control signal V_{T}. Furthermore, the current feedback unit 40 senses currents applied to the actuator 50, and feeds back currents to the actuator 50 by combining fed-back signals. The actuator 50 is driven by the sum signal V_{F}+V_{R} and the difference signal V_{F}−V_{R} associated with the focusing control signal V_{F} and the tilting control signal V_{R}. The actuator 50 feeds back the signals to the current feedback unit 40. Optionally, the optical pick-up device can drive the actuator 50 with a voltage sensitivity control signal by separately forming the current feedback unit 40 without changing the system driving IC 21 arranged within a conventional optical pick-up driver 20.

In this case, the current feedback unit 40 is implemented by a one-chip application specific integrated circuit (ASIC), and is mounted on a predetermined portion of the optical pick-up 100. Here, the ASIC is a generic term including a custom IC and a standard IC for a specific purpose. The ASIC is different from a standard IC or a universal IC for an unspecific purpose such as a TTL memory, a microprocessor, etc. and means a dedicated IC appropriate for the specific purpose.

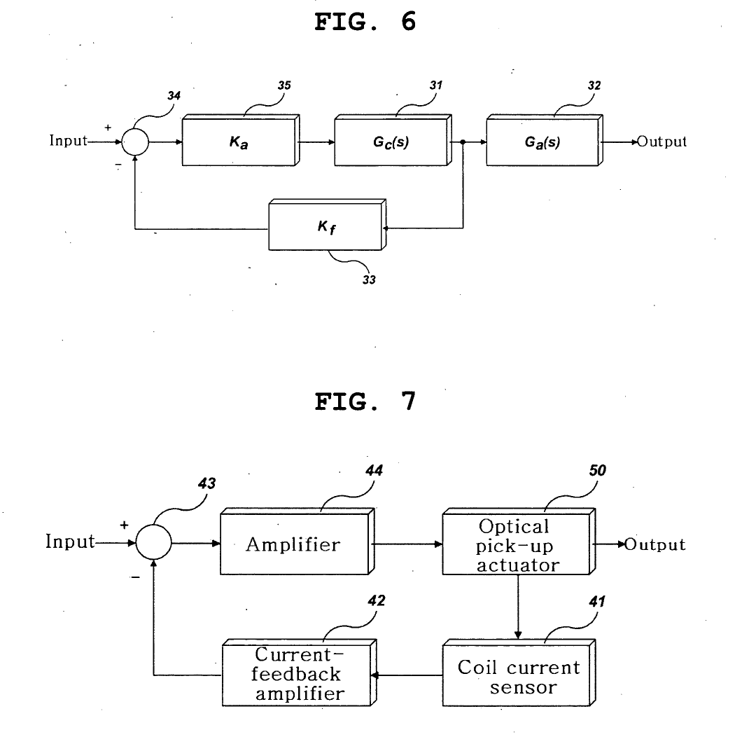

FIG. 6 is a view illustrating a gain transfer function of an optical pick-up actuator capable of controlling voltage sensitivity in accordance with the present invention.

As shown in FIG. 6, the optical pick-up actuator in accordance with the present invention employs not only a coil transfer function G_{c}(s) 31 and an actuator transfer function Gₐ(s) 32 associated with a conventional moving-magnet actuator, but also Kₐ 35 being a transfer function of an amplifier and K_{f} 33 being a transfer function of a current feedback unit.

The gain transfer function (G′(s)) of the optical pick-up actuator in accordance with the present invention is given by the following Equation 4, in the form of a feedback transfer function.

$${G}^{′} ( s ) = \frac{{K}_{c}}{{τ}_{c} s + 1} \qquad Equation 4$$

In the above Equation 4, τ_{c} denotes a time constant of a coil having a phase delay. The time constant τ_{c} is given by the following Equation 5.

$${τ}_{c} = \frac{L}{{K}_{a} {K}_{f} + R} \qquad Equation 5$$

In the above Equation 5, L and R denote inductance of the coil and resistance of the coil, respectively. K_{c} being a transfer function of the coil is given by the following Equation 6.

$${K}_{c} = \frac{{K}_{a}}{{K}_{a} {K}_{f} + R} \qquad Equation 6$$

As the amplifier and the current feedback unit are added to the optical pick-up device, a phase delay can be overcome by adjusting the time constant of the coil and a gain. The gain is adjusted by Kₐ 35 and K_{f} 33, and the voltage sensitivity can be increased by adjusting the gain. Here, a reference numeral 34 denotes an adder for adding a negative signal of K_{f} 33 based on a negative feedback to an input signal.

For example, if Kₐ 35 and K_{f} 33 are “1” and “0”, respectively, K_{c}=1/R. At this time, the transfer function K_{c} is the same as the transfer function based on Equation 2 contained in “Description of the Related Art”. That is, where a fed-back signal does not exist, the transfer functions are the same as each other.

FIG. 7 is a schematic diagram illustrating the configuration of an optical pick-up device for implementing the gain transfer function shown in FIG. 6. A coil current sensor 41 senses a current going through each coil arranged in an optical pickup actuator 50, and outputs the sensed current to a current-feedback amplifier 42. An adder 43 adds a negative signal of an output of the current-feedback amplifier 42 based on a negative feedback to an input signal. An amplifier 44 receives and amplifies an output signal of the adder 43. The amplified signal controls the optical pick-up actuator 50. That is, a control signal is inputted into the optical pick-up actuator 50 so that voltage sensitivity can be improved.

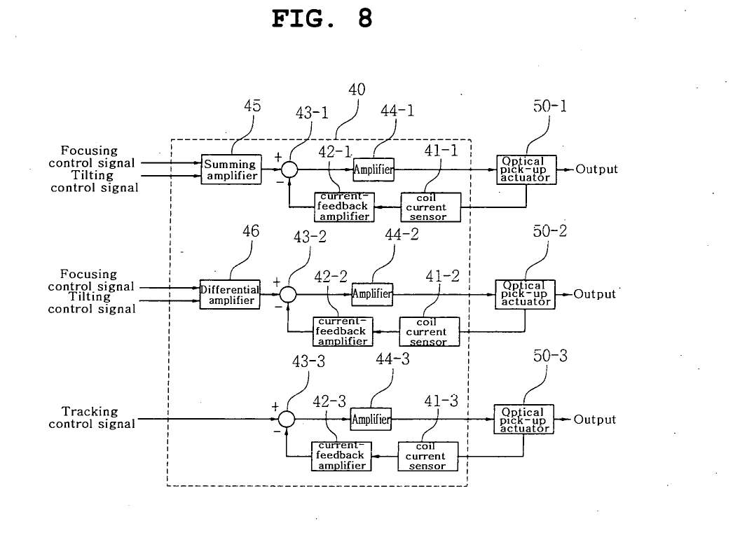

FIG. 8 is a schematic diagram illustrating an optical pick-up device equipped with a current feedback unit for controlling voltage sensitivity in accordance with an embodiment of the present invention. In a current feedback unit 40, coil current sensors 41-1, 41-2 and 41-3 sense magnitudes of currents corresponding to voltages applied to actuators. Current-feedback amplifiers 42-1, 42-2 and 42-3 output feedback signals for controlling voltage sensitivity in response to the sensed coil currents. A summing amplifier 45 outputs a sum signal by summing a focusing control signal and a tilting control signal. A differential amplifier 46 outputs a difference signal by carrying out a differential amplification for the focusing control signal and the tilting control signal. Adders 43-1 and 43-2 output actuator driving signals by adding the outputs of the summing amplifier 45 and differential amplifier 46 to the outputs of the current-feedback amplifiers 42-1 and 42-2, respectively. An adder 43-3 outputs an actuator driving signal by adding a tracking control signal to an output of the current-feedback amplifier 42-3. Amplifiers 44-1, 44-2 and 44-3 amplify the actuator driving signals.

The coil current sensors 41-1, 41-2 and 41-3, current-feedback amplifiers 42-1, 42-2 and 42-3, adders 43-1, 43-2 and 43-3, amplifiers 44-1, 44-2 and 44-3, summing amplifier 45, and differential amplifier 46 are implemented by a one-chip ASIC. The current feedback unit 40 receives the focusing and tilting control signals and then feeds back the sum and difference signals to optical pick-up actuators 50-1 and 50-2. The current feedback unit 40 receives a tracking control signal and then feeds back the tracking control signal to the optical pick-up actuator 50-3. The summing amplifier 45 and differential amplifier 46 produce the sum signal and the difference signal according to the focusing and tilting control signals, respectively. In place of the operation amplifier 45 or 46, an adder, subtracter or etc. can be used.

In the optical pick-up device capable of controlling the voltage sensitivity in accordance with the present invention, the current feedback circuit can be implemented by the one-chip ASIC, and can be mounted on a predetermined portion of the optical pick-up. Since the space of a base surface on which optical components of the optical pick-up using the moving-magnet type actuator can be seated, is sufficient, the current feedback circuit can be easily implemented by the one-chip IC.

Where the one-chip ASIC of the current feedback unit shown in FIG. 8 applicable to a three-axis driving actuator is arranged on the optical pick-up 100 shown in FIG. 5, e.g., a predetermined portion of a base surface on which optical components are seated in an optical pick-up equipped with a moving-magnet type actuator, the optical pick-up capable of controlling voltage sensitivity can be implemented with minimizing a change of the conventional system driving IC 21.

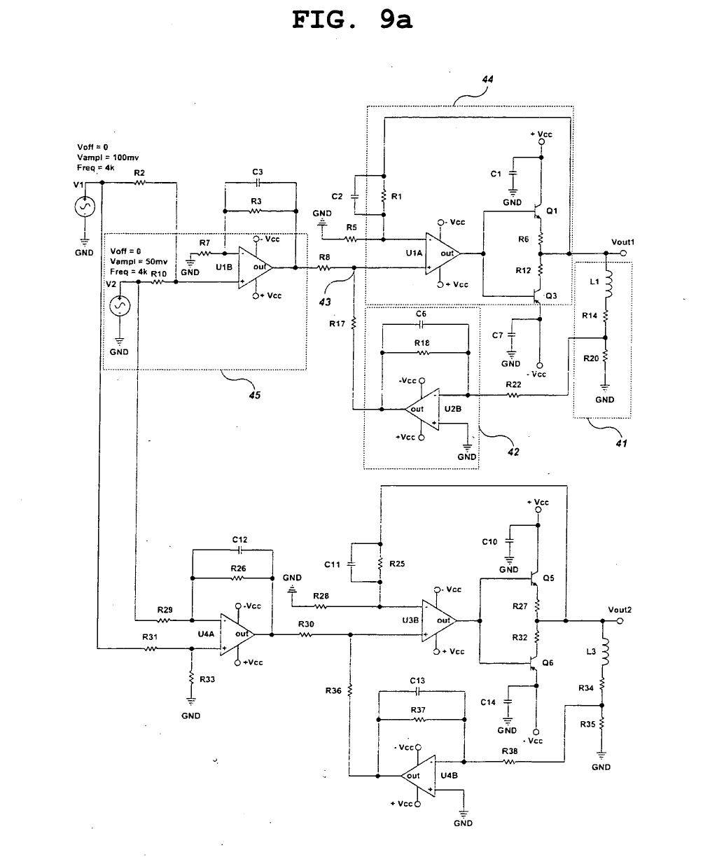

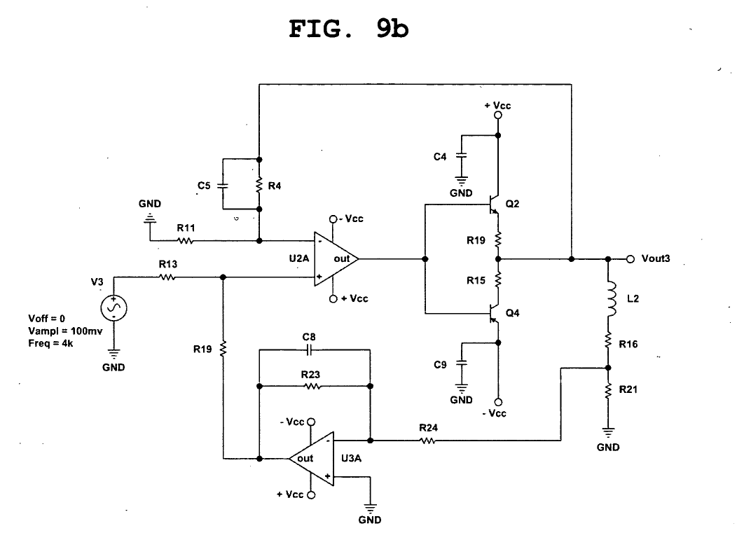

FIGS. 9A and 9B are circuit diagrams illustrating the current feedback circuit in accordance with an embodiment of the present invention. FIG. 9A shows the case where the sum signal and the difference signal associated with the focusing control signal and the tilting control signal are inputted. FIG. 9B shows the case where the tracking control signal is inputted. At this time, the control signals are inputted as alternating voltages for driving the actuator.

In FIG. 9A, V1 and V2 denote a focusing control voltage and a tilting control voltage, respectively. At a frequency 4 kHz, an alternating voltage 100 mV corresponding to the focusing control voltage V1 and an alternating voltage 50 mV corresponding to the tilting control voltage are inputted into the current feedback circuit. Except for the fact that an upper stage of the current feedback circuit generates the sum signal V1+V2 and a lower stage of the current feedback circuit generates the difference signal V1−V2, the upper and lower stages are substantially equal to each other. Accordingly, only the upper stage of the current feedback circuit will be described. In the current feedback circuit, R1˜R38 are resistors, C1˜C4 are capacitors, L1˜L3 are coils, V1˜V3 are alternating voltages, U1A˜U4B are amplifiers, and Q1˜Q6 are switching transistors.

Referring to FIG. 9A, a reference numeral 45 denotes a summing amplifier for generating a sum signal of the focusing and tilting control voltages. A reference numeral 43 denotes an adder for adding an output of the summing amplifier to a negative feedback output associated with the current-feedback amplifier 42.

A reference numeral 44 denotes an amplifier for amplifying control voltages received from the adder. The adder 44 outputs a corresponding coil L1 under the control of switching transistors Q1 and Q3. A reference numeral 41 denotes a coil current sensor. The coil current sensor 41 can sense a current going through the coil L1, which is connected to the resistors R14 and R20 in serial.

The coil current sensed by the coil current sensor 41 is inputted into the current feedback amplifier 42. The coil current is inputted into the adder 43 through a negative feedback loop. Accordingly, a feedback circuit capable of controlling the voltage sensitivity of the actuator is formed. Here, the amplifiers U1A, U1B and U2B are individual amplifiers of an amplifier module IC. According to a connection manner, the amplifiers have a signal combining function, a signal amplification function and a negative feedback function. Further, Vcc and −Vcc are power supply voltages. Typically, the power supply voltages Vcc and −Vcc are +5V and −5V, respectively. GND denotes a ground.

Except for the fact that FIG. 9B does not include the summing amplifier 45 as compared with the upper stage of the circuit feedback circuit shown in shown in FIG. 9A, the upper stage of the circuit feedback circuit shown in FIG. 9A is substantially equal to a circuit shown in FIG. 9B. Accordingly, the circuit shown in FIG. 9B will not be described in detail. In FIG. 9B, L2 denotes a tracking coil.

The circuit feedback circuit shown in FIGS. 9A and 9B has been described as an example. The present invention is not limited to the circuit feedback circuit. Various modifications, additions, and substitutions to the circuit feedback circuit are possible.

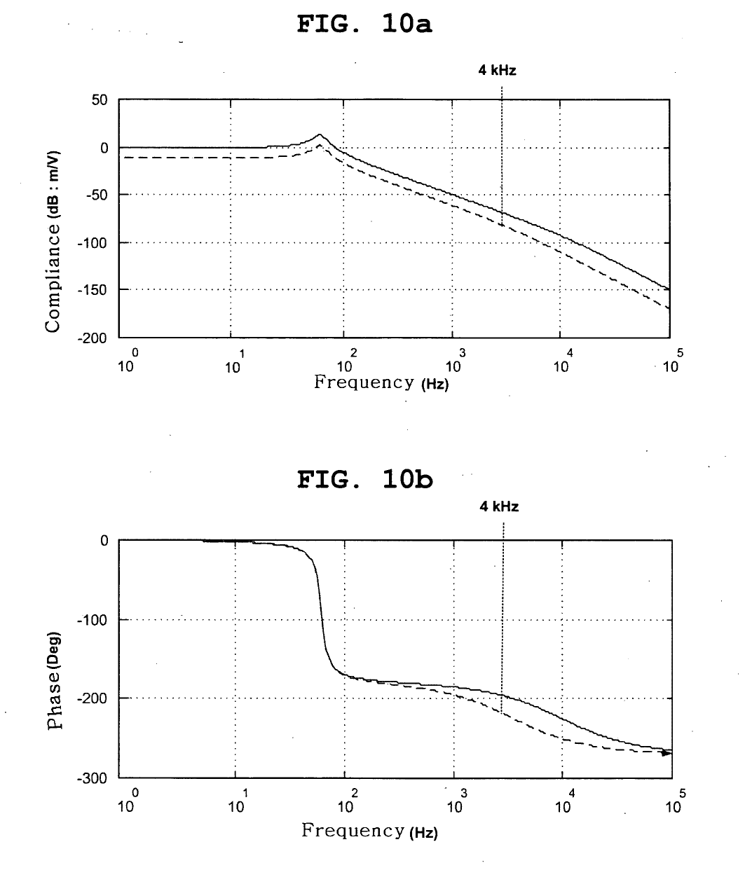

FIGS. 10A and 10B are graphs illustrating a result of voltage sensitivity control and a result of phase correction associated with the optical pick-up actuator in accordance with the present invention. In FIGS. 10A and 10B, an X-axis denotes a frequency (kHz). A Y-axis shown in FIG. 10A denotes compliance (dB: m/V) associated with the voltage sensitivity. A Y-axis shown in FIG. 10B denotes a phase (deg) associated with the voltage sensitivity.

Referring to FIG. 10A, it will be understood that voltage sensitivity indicated by a solid line in accordance with the present invention is improved as compared with voltage sensitivity indicated by a dotted line, at a frequency 4 kHz. Further, in FIG. 10B, a phase required at the frequency 4 kHz must be within about −220°. However, where a compensation operation is not applied, a phase of about −228° is obtained at the frequency 4 kHz as indicated by a dotted line. On the other hand, where the compensation operation is applied, a phase of about −202° is obtained at the frequency 4 kHz as indicated by a solid line. It is understood that a phase of about 26° is compensated by the compensation operation. The frequency 4 kHz has been used as an example. Therefore, a characteristic criterion of the optical pick-up driving an object lens is not limited to the frequency 4 kHz.

The moving-magnet type actuator, equipped with a set of magnets as a driver and connected to wires, which operates in a focusing direction and a tracking direction, includes a current feedback circuit. The current feedback circuit including a voltage amplifier and a current-feedback amplifier is implemented by a one-chip, and is arranged on a predetermine portion of the optical pick-up. As a result, a phase delay and voltage sensitivity associated with a tilting operation of the actuator can be improved.

As apparent from the above description, the present invention provides an optical pick-up actuator equipped with a current feedback circuit, which can increase voltage sensitivity of a moving-magnet type actuator.

Further, the present invention provides an optical pick-up device equipped with a current feedback circuit, which can improve a tilting operation of an actuator by increasing voltage sensitivity of a moving-magnet type actuator.

Although the present invention has been described in connection with specific preferred embodiments, those skilled in the art will appreciate that various modifications, additions, and substitutions to the specific elements are possible, without departing from the scope and spirit of the present invention as disclosed in the accompanying claims.

What is claimed is:

1. An optical pick-up device, comprising:
a system driving integrated circuit (IC) for providing a tracking control signal, a focusing control signal and a tilting control signal to drive at least one actuator;
the actuator driven in response to a sum signal and a difference signal, associated with the focusing control signal and the tilting control signal, and the tracking control signal; and
a current feedback unit for outputting, to corresponding coils of the actuators, voltages corresponding to the sum and difference signals generated by combining the focusing control signal and the tilting control signal and the tracking control signal, sensing currents applied to the actuator coils, and applying feedback signals to the actuator to control voltage sensitivity and phase of the actuator.

2. The optical pick-up device as set forth in claim 1, wherein the current feedback unit is implemented by a one-chip application specific integrated circuit (ASIC), and is mounted on a base surface of the optical pick-up device.

3. The optical pick-up device as set forth in claim 1, wherein the feedback signals generated by the current feedback unit are negative feedback signals.

4. The optical pick-up device as set forth in claim 1, wherein the current feedback unit comprises:
a plurality of coil current sensors for sensing magnitudes of the currents corresponding to the voltages applied to the actuator;
a plurality of current-feedback amplifiers for outputting the feedback signals for controlling the voltage sensitivity in response to the sensed coil currents;
operation amplifiers for outputting the sum signal and the difference signal associated with the focusing control signal and the tilting control signal;
a plurality of adders each outputting an actuator driving signal by adding an output of each operation amplifier to an output of each current-feedback amplifier; and
a plurality of amplifiers each amplifying the actuator driving signal and outputting the amplified signal.

5. The optical pick-up device as set forth in claim 4, wherein each coil current sensor senses a coil current from a voltage at an end of a resistor connected to an actuator coil in serial.

6. The optical pick-up device as set forth in claim 5, wherein a resistance value of the resistor is 1 Ω.

7. A tilt actuator being driven in response to a sum signal and a difference signal, associated with a focusing control signal and a tilting control signal, and a tracking control signal, comprising:
a current feedback unit for outputting, to corresponding coils of the actuator, voltages corresponding to the sum and difference signals generated by combining the focusing control signal and the tilting control signal and the tracking control signal, sensing currents applied to the actuator coils, and generating feedback signals to control voltage sensitivity and phase of the actuator.

8. The tilt actuator as set forth in claim 7, wherein the actuator is a moving-magnet type actuator.

9. The tilt actuator as set forth in claim 7, wherein the current feedback unit is implemented by a one-chip application specific integrated circuit (ASIC), and is mounted on a base surface of an optical pick-up.

10. The tilt actuator as set forth in claim 7, wherein the feedback signals generated by the current feedback unit are negative feedback signals.

11. The tilt actuator as set forth in claim 7, wherein the current feedback unit comprises:
a plurality of coil current sensors for sensing magnitudes of the currents corresponding to the voltages applied to the actuator;
a plurality of current-feedback amplifiers for outputting the feedback signals for controlling the voltage sensitivity in response to the sensed coil currents;
operation amplifiers for outputting the sum signal and the difference signal associated with the focusing control signal and the tilting control signal;
a plurality of adders each outputting an actuator driving signal by adding an output of each operation amplifier to an output of each current-feedback amplifier; and
a plurality of amplifiers each amplifying the actuator driving signal and outputting the amplified signal.

12. The tilt actuator as set forth in claim 11, wherein each coil current sensor senses a coil current from a voltage at an end of a resistor connected to an actuator coil in serial.
